(19) United States
(12) Patent Application Publication
(10) Pub. No.: US 2010/0011310 A1
(43) Pub. Date: Jan. 14, 2010

(54) Method, Device, Computer Program and Graphical User Interface Used for the Selection, Movement and De-Selection of an Item

(75) Inventor: Roope Rainisto, Helsinki (FI)

Correspondence Address: HARRINGTON & SMITH, PC, 4 RESEARCH DRIVE, Suite 202, SHELTON, CT, 06484-6212, US

(73) Assignee: NOKIA CORPORATION, Espo (FI)

(21) Appl. No.: 11/991,707

(22) PCT Filed: Sep. 30, 2005
(86) PCT No.: PCT/IB2005/003374

§ 371 Date: Aug. 3, 2009

(51) Int. Cl. G06F 3/048

(52) U.S. Cl. 715/769; 715/810

(57) ABSTRACT

A method of controlling an action performed as a result of a drag and drop operation, the method including displaying a menu of multiple actions during the drag and drop operation, each of the actions being associated with a different respective portion of a display; and performing an action associated with a portion of the display that coincides with a waypoint in the drag and drop operation.

### FIELD OF THE INVENTION

Embodiments of the present invention relate to a method, device, computer program and graphical user interface used for the selection, movement and de-selection of an item or a group of multiple items e.g. a ‘drag and drop’ operation.

### BACKGROUND TO THE INVENTION

A ‘drag and drop’ operation involves selecting an item (grabbing), moving the selected item across a display (dragging), and then de-selecting the selected item (dropping).

A problem arises in that it is not always apparent what action will be performed as a result of de-selecting the selected item. For example, if a file is selected, moved and dropped into a folder it is not always apparent whether the file will be copied or moved to the folder.

It would be desirable to improve the drag and drop operation.

### BRIEF DESCRIPTION OF THE INVENTION

According to one embodiment of the invention there is provided a method of controlling an action performed as a result of a drag and drop operation, the method comprising: displaying a menu of multiple actions during the drag and drop operation, an action being associated with a respective portion of a display; and performing an action associated with a portion of the display that coincides with a waypoint in the drag and drop operation.

According to another aspect of this embodiment of the invention there is provided a method of performing an action using first and second data entities, comprising: enabling user controlled selection of a first item that visually represents the first data entity on a display; while the first item is selected, enabling user controlled movement of the selected first item across the display; displaying a menu of one or more actions, an action being associated with a respective portion of the display; enabling user controlled selection of an action from the menu, wherein the user controlled selection of an action comprises user controlled movement of the selected first item to the portion of the display associated with the action; and performing the selected action using the first data entity and the second data entity in response to user controlled movement of the selected first item to a second item that visually represents the second data entity, followed by the de-selection of the selected first item.

According to another aspect of this embodiment of the invention there is provided an electronic device comprising: a display for displaying items that visually represent data entities and for displaying a menu of one or more actions, an action being associated with a respective portion of the display; and means for receiving a user input for selection of the item, for moving the selected item across the display, and for de-selecting the selected item, wherein the electronic device is operable so that: a first data entity is selected by selecting a first item that visually represents the first data entity; an action is selected by moving the selected item to the portion of the display associated with the action; and the selected action is performed using the first data entity and a second data entity by moving the selected first item to a second item that visually represents the second data entity and then de-selecting the selected first item.

According to another aspect of this embodiment of the invention there is provided a computer program comprising computer program instructions which when loaded into a processor: control displaying of a menu of one or more actions, an action being associated with a respective portion of the display; detect user controlled selection of an action from the menu, wherein the user controlled selection of an action comprises user controlled movement of a selected first item to the portion of the display associated with the action; and initiate performance of the selected action, which uses a first data entity and a second data entity, in response to the selected first item that visually represents the first data entity being moved to a second item that visually represents the second data entity and de-selected.

According to another aspect of this embodiment of the invention there is provided a graphical user interface that: enables user controlled selection of a first item that visually represents a first data entity on a display; enables user controlled movement of the selected first item across the display; displays a menu of one or more actions, an action being associated with a respective portion of the display; enables user controlled selection of an action from the menu, wherein the user controlled selection of an action comprises user controlled movement of the selected first item to the portion of the display associated with the action, and enables performance of the selected action, which uses the first data entity and a second data entity, in response to the selected first item being moved to a second item that visually represents the second data entity and de-selected.

Selection of an action has been integrated as a part of the drag and drop process. This advantageously allows a user to easily control the action performed on terminating the drag and drop operation without interrupting the drag and drop operation.

The menu may be used to clearly identify the range of actions available for selection. The menu may also be used to clearly identify the selected action after its selection.

According to another embodiment of the invention there is provided a method of controlling an action performed as a result of a drag and drop operation, the method comprising: displaying a temporary menu of multiple actions during a drag and drop operation, an action being associated with a respective portion of a display; and performing an action associated with a portion of the display that coincides with a waypoint or endpoint in the drag and drop operation.

According to another aspect of this embodiment of the invention there is provided a method of performing an action on a data entity, comprising: enabling user controlled selection of an item that visually represents the data entity on a display; while the item is selected, enabling user controlled movement of the selected item across the display; automatically displaying a menu of one or more actions, an action being associated with a respective portion of the display; enabling user controlled selection of an action from the menu, wherein the user controlled selection of an action comprises user controlled movement of the selected item to the portion of the display associated with the action; performing the selected action on the data entity in response to user de-selection of the selected item; and automatically terminating the display of the menu in response to user de-selection of the selected item.

Selection of an action has been integrated as a part of the drag and drop process. This advantageously allows a user to easily control the action performed on terminating the drag and drop operation without interrupting the drag and drop operation. The menu is displayed during the drag and drop operation and therefore does not unnecessarily occupy space in the display.

### BRIEF DESCRIPTION OF THE DRAWINGS

For a better understanding of the present invention reference will now be made by way of example only to the accompanying drawings in which:

FIG. 1 schematically illustrates an electronic device;

FIG. 2 illustrates an embodiment of the invention as a process in which a menu is used as a waypoint in the drag and drop operation;

FIGS. 3A to 3E illustrate an example GUI at different stages of the process illustrated in FIG. 2;

FIG. 4 illustrates an example GUI for another embodiment of the invention in which a menu is used as an endpoint in the drag and drop operation.

### DETAILED DESCRIPTION OF EMBODIMENTS OF THE INVENTION

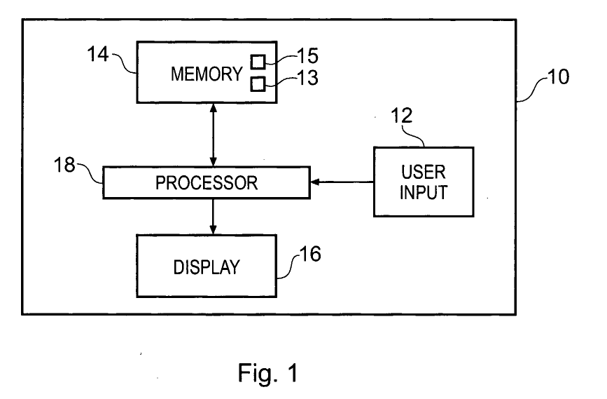

FIG. 1 schematically illustrates an electronic device 10. Only the features referred to in the following description are illustrated. It should, however, be understood that the device 10 may comprise additional features that are not illustrated. The electronic device 10 may be, for example, a personal computer, a personal digital assistant, a mobile cellular telephone, a television, a video recorder in combination with a television, or any other electronic device that uses a graphical user interface.

The illustrated electronic device 10 comprises: a user input 12, a memory 14, a display 16 and a processor 18. The processor 18 is connected to receive input commands from the user input 12 and to provide output commands to the display 16. The processor 18 is also connected to write to and read from the memory 14.

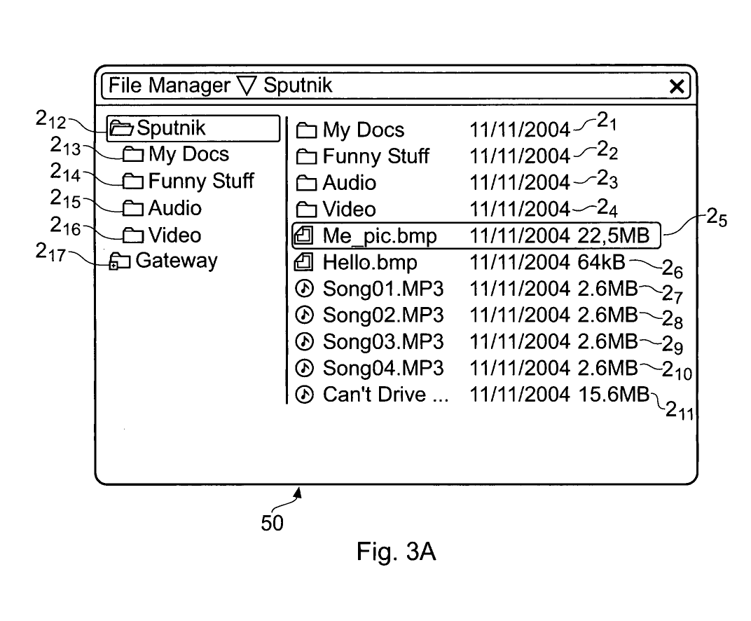

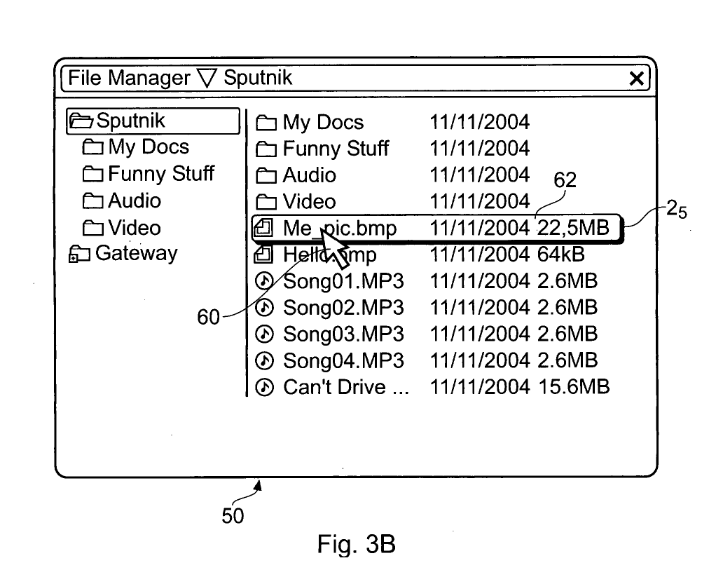

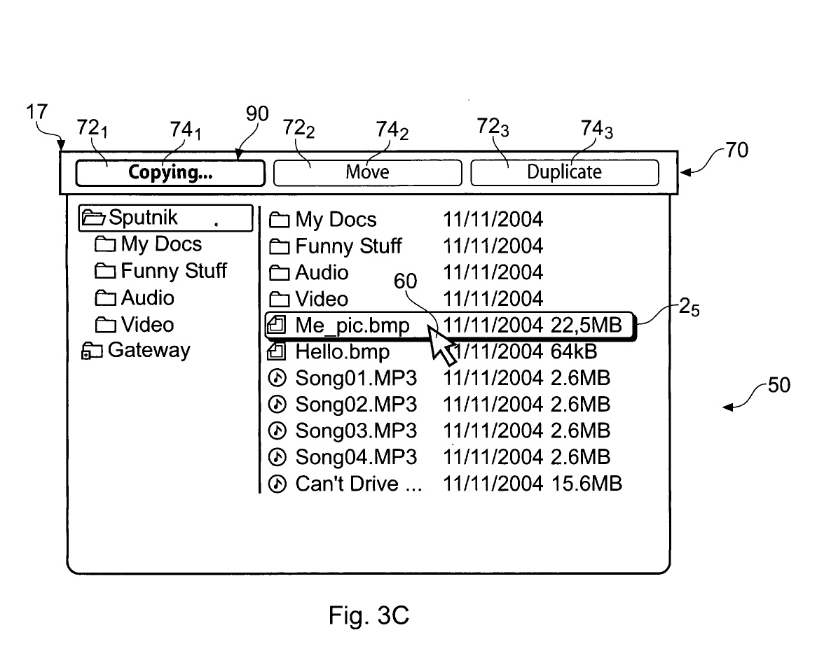

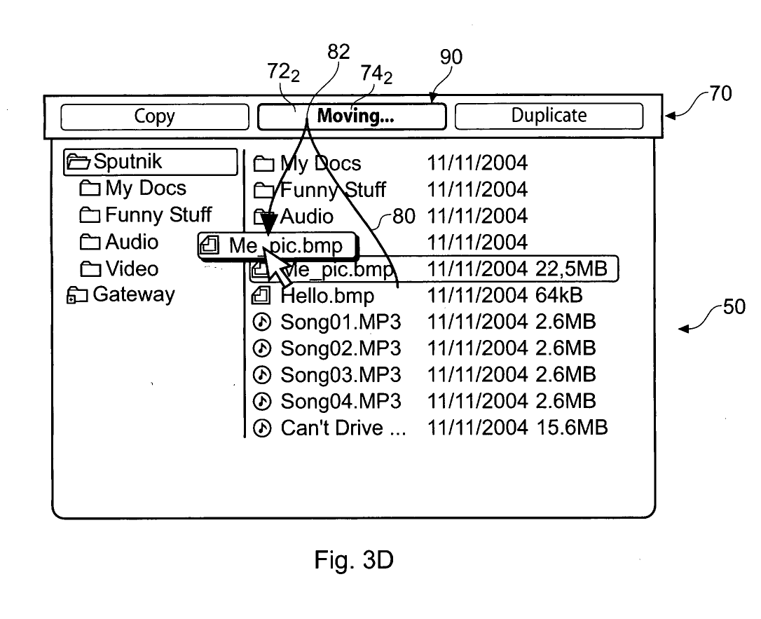

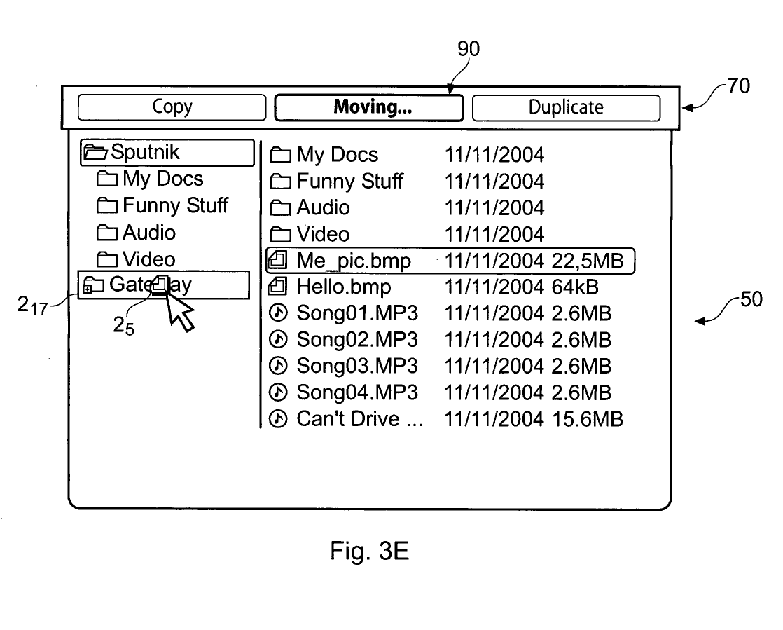

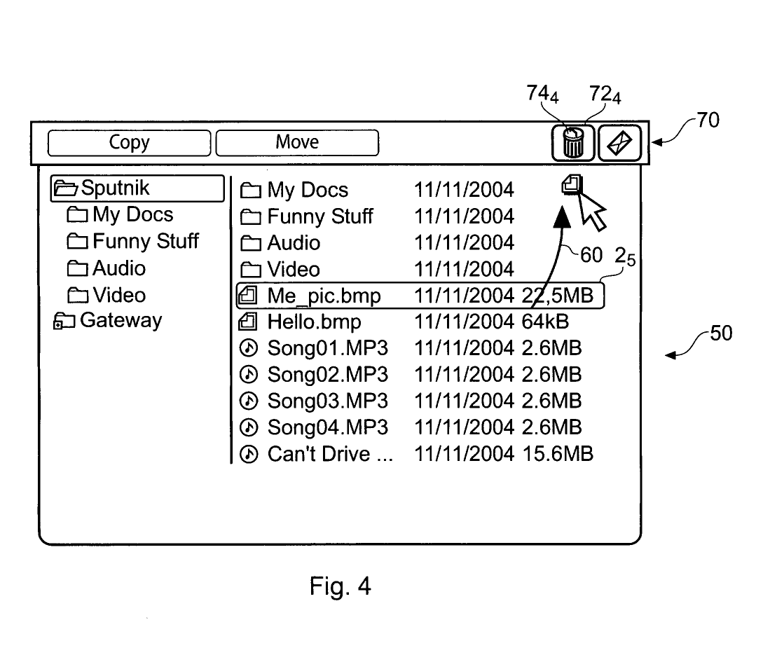

The display 16 presents a graphical user interface (GUI). An example GUI is illustrated in FIGS. 3A-3E and FIG. 4. The GUI 50 comprises a plurality of different items 2ₙ visually representing different data entities. A data entity may be, for example, an executable program, a data file, a folder etc.

The user input 12 is used to perform a ‘drag and drop’ operation. A drag and drop operation involves selecting an item (grabbing), moving the selected item across the display (dragging), and then de-selecting the selected item (dropping). The user input 12 includes a selector mechanism for selecting and de-selecting an item and a motion mechanism for moving a selected item within the display. The selector mechanism and motion mechanism may be incorporated within a single device such as a joy-stick, mouse, track-ball, touch-screen etc. or they may be realized as a plurality of separate devices such as an arrangement of input keys.

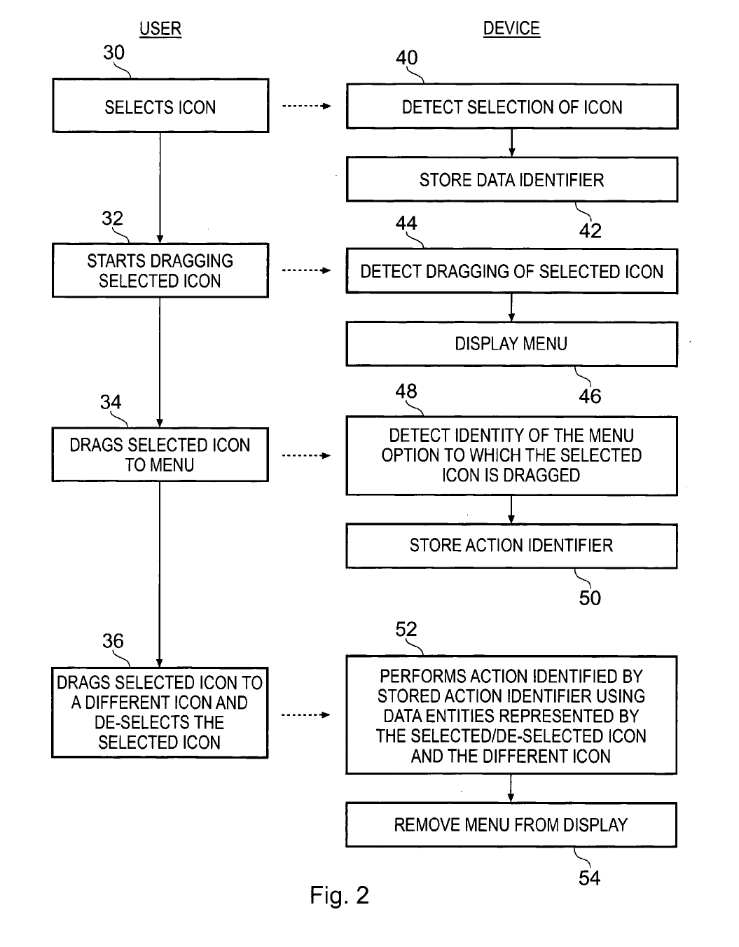

The memory 14 stores computer program instructions 20, which when loaded into the processor 18, enable the processor 16 to control the operation of the device 10 as described below. The computer program instructions 20 provide the logic and routines that enables the electronic device 10 to perform the methods illustrated in FIG. 2.

The computer program instructions 20 may arrive at the electronic device 10 via an electromagnetic carrier signal or be copied from a physical entity 22 such as a computer program product, a memory device or a record medium such as a CD-ROM or DVD.

The method of using the device is schematically illustrated in FIG. 2. The actions performed by a user are detailed in the left-hand column under the heading ‘user’. The corresponding actions performed by the device are detailed in the right-hand column under the heading ‘device’. The actions are presented in time sequence order with the first action 30 being presented at the top left and the final action 54 being presented at the bottom right.

The method starts, at step 30, with user controlled selection of a first item that represents a first data entity. An example of user controlled selection is illustrated in FIG. 3B. A cursor 60 is moved over item 2₅ using the motion mechanism of the user input 12. The item 2₅ is then selected by actuating the selector mechanism of the user input 12. The item 2₅ is visually highlighted to indicate that it is selected. In this example, the highlighting 62 borders the item 2₅.

In one embodiment, the user may select the first item, and maintain its selection, by, for example, moving a cursor 60 over the item (e.g. by moving a mouse) and then continuously actuating the selector mechanism (e.g. holding down the right mouse key). Releasing the selector mechanism would de-select the first item.

In another embodiment, the user may select the first item, and maintain its selection, by, for example, touching a stylus to a touch sensitive screen where the first item is displayed and keeping the stylus in contact with the screen. Removing the stylus from contacting the touch sensitive screen would de-select the first item.

In a further embodiment, the user may select the first item, and maintain its selection, by, for example, moving a cursor 60 over the item and then actuating once a toggle selector mechanism. Re-actuating the toggle selector mechanism would de-select the first item.

In response to step 30, the device detects, at step 40, the selection of the first item 2₅. In response, at step 42, the device 10 stores a data identifier 15 in the memory 14 that identifies the first data entity visually represented by the first item 2₅.

Then the user, at step 32, starts user controlled movement of the selected first item 2₅ across the display 16. This is illustrated in FIG. 3C.

In response to step 32, the device, at step 44, detects the motion of the selected item across the display and, in response, automatically starts to display a menu 70. The displaying of the menu is automatic in the sense that it occurs inevitably without user input. The menu 70 is displayed in this example in response to the initiation of the movement of an item. In other embodiments, the menu 70 may alternatively be displayed in response to the user selection of the item.

The menu presents a plurality of menu options each of which corresponds to an action for user selection. A menu option is associated with a distinct and separate portion of the display and the portion of the display has a label identifying its associated action. The label may comprise an icon, a graphical image, text, sound etc.

In the example illustrated in FIG. 3C, the menu 70 presents a plurality of menu options—‘Copying’, ‘Move’, ‘Duplicate’ each of which corresponds to an action for user selection. Each of the menu options ‘Copying’, ‘Move’, ‘Duplicate’ is associated with a respective, distinct and separate portion 72₁, 72₂, 72₃ of the display 16 and each of the portions of the display has its own label 74₁, 74₂, 74₃ identifying its associated action.

The portions 72₁, 72₂, 72₃ of the display 16 are contiguous and are located at the edge 17 of the display 16 so that the menu options are located together in an easily accessible location.

The menu 70 may be displayed in the same position in the display when other items 2ₘ in the display are selected and moved. Alternatively, the position of the menu 70 may move intelligently. For example, the menu may be positioned at the edge of the display where there is most adjacent free space or it may be predicatively positioned at the edge of the display towards which the selected item is being moved. For example, in FIG. 3C, the icon 60 would be moving upwards towards the edge 17 of the display 16.

The menu is displayed at least during movement of the selected item and is removed from the display when the item is de-selected i.e. the drag and drop operation is completed. The menu is therefore only temporarily displayed. It appears in response to user action (the start of the drag and drop operation) and disappears in response to user action (the end of the drag and drop operation).

The menu displayed may be dependent upon the identity of the item being dragged and dropped. Thus different menus are displayed when different items are selected and moved.

For example, a data entity may have an assigned data type, and the data type may have an associated set of actions. When an item 2ₙ representing such a data entity is selected and moved, the menu 70 displayed comprises selectable options corresponding to the set of actions. The menu 70 may only comprise portions 72ₙ for each of the set of actions or, alternatively, the menu 70 may comprise standard portions 72ₙ but only those associated with the actions in the set of actions would be activated, the remaining portions being de-emphasized e.g. by dimming or the order of the standard portions 72ₙ may be prioritized so that the portions associated with actions are presented first or closest to the selected item.

Then at step 34, the user continues to move the selected item. The user moves the selected item to the portion of the display in the menu that is labeled with the desired action. In the example of FIG. 3D, the user moves the selected item 2₅ to the portion 72₂ of the display in the menu 70 that is labeled 74₂ with the desired action ‘Moving’. The route 80 traced by the selected item therefore has a waypoint 82 over the portion 72₂ of the display 16. A waypoint 82 is any point in the route 80 that the selected item takes as it is moved across the display.

In response to step 34, the device, at step 48, detects the identity of the menu option to which the selected item is moved. In response, at step 50, the device stores an action identifier 13 in memory 14 that identifies the action associated with that menu option and, optionally, highlights that menu option. If the selected item is subsequently moved to another menu option, before de-selection, then the stored action identifier is replaced with the action identifier that identifies the action that is associated with that other menu option and the other menu option is highlighted. In the example of FIG. 3D, the last of the waypoints 82 on the route 80 that coincides with a portion 72ₙ of the menu 70, coincides with the portion 72₂. The action identifier 13 identifies the action ‘Moving’ associated with the portion 72₂. The portion 72₂ of display 16 is highlighted 90 and remains highlighted until the selected item 2₅ is de-selected i.e. until the drag and drop procedure ends.

Then at step 36, the user continues to move the selected item to a second item where the user de-selects the selected item. In the example of FIG. 3E, the selected item 2₅ (an icon for a picture) is moved over the item 217 (an icon for a folder). The Fig illustrates the GUI 50 before de-selection.

In response, at step 52, the device 10 detects that the selected first item has been moved to the second item and the de-selection of the selected item. In response to this detection, the device performs the action identified by the stored action identifier 13 using the data entity identified by the stored data identifier 15 and the data entity represented by the second item. This completes the drag and drop operation. The menu 70 will then be removed from the display 16 at step 54. Thus in the example of FIG. 3E, after de-selection of the selected item 2₅ the device 10 will move the picture file ‘Me_pic.bmp’ into the folder ‘Gateway’.

Referring back to FIG. 3C, when ah item 2ₙ is selected, a menu option may be selected by default without having to drag the selected item to the menu. In the illustrated example, the default option is to copy. The selection of this option is apparent from the highlighting 90 and the change in the label 74₁ from “Copy” to “Copying”. The selected item 2₅ may be dragged to the menu to change the selected option as illustrated in FIG. 3D. In FIG. 3D the Move option is selected by dragging the selected item 2₅ so that waypoint 82 on the route 80 coincides with portion 72₂ of the menu 70. The selection of this option is apparent from the highlighting 90 and the change in the label 74₂ from “Move” to “Moving”.

In an alternative embodiment, the method illustrated in FIG. 2 is modified so that actions can be performed using the first data entity that do not involve a second data entity. These actions may be, for example:
a) actions that do not, involve data entities as destinations such as the actions: open, delete, send, play, print etc. and/or
b) actions that have predefined destinations such as the actions: move to trash, copy to clipboard, paste from clipboard.

These actions are performed by de-selecting the selected item while it is positioned over the portion of the menu corresponding to a desired action i.e. a menu option is an end-point of drag and drop operation. An example is illustrated in FIG. 4. The selected item 2₅ is moved along route 60 so that it coincides with the portion 72₄ of the menu 70 that is labeled 74₄ as a trash can. The selected item 2₅ is de-selected while it is located over the portion 72₄ terminating the route 60 at an end-point that coincides with the portion 72₄. The device 10 subsequently deletes the data entity, the picture file Me_pic.bmp, associated with the de-selected item 2₅.

In a further embodiment, the menu temporarily presented on the display in response to moving a selected item has menu options that are selected when they are waypoints in the movement of the selected item to its destination item (as described with reference to FIG. 2) and also menu options that are selected when they are endpoints in the movement of the selected item (as described in the preceding paragraph).

Although embodiments of the present invention have been described in the preceding paragraphs with reference to various examples, it should be appreciated that modifications to the examples given can be made without departing from the scope of the invention as claimed. For example, the drag and drop operation has been described as carried out on one item. It possible for the drag and drop operation to be carried out on several items simultaneously. That is multiple items are selected and dragged to the menu. Thus in the foregoing description, where reference is made to the selection, dragging and dropping of an item, reference could also have been made to the selection, dragging and dropping of a group of multiple items.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method of controlling an action performed as a result of a drag and drop operation, the method comprising:
displaying a menu of multiple actions during the drag and drop operation, an action being associated with a respective portion of a display; and
performing an action associated with a portion of the display that coincides with a waypoint in the drag and drop operation.

2. A method as claimed in claim 1, wherein the menu is automatically displayed when the drag and drop operation is initiated.

3. A method as claimed in claim 1, wherein the menu is only displayed during the drag and drop operation.

4. A method as claimed in claim 1, wherein the menu has a content and the content of the menu depends upon which one of a plurality of items is involved in the drag and drop operation.

5. A method as claimed in claim 1, wherein the position of the menu varies for different drag and drop operations.

6. A method as claimed in claim 1, wherein the menu is displayed at an edge of the display.

7. A method as claimed in claim 1, wherein a portion of the display that is associated with an action is labeled with a label that identifies
that action.

8. A method as claimed in claim 1, wherein a portion of the display that coincides with a waypoint in the drag and drop operation is highlighted.

9. A method of performing an action using first and second data entities, comprising:
enabling user controlled selection of a first item that visually represents the first data entity on a display;
while the first item is selected, enabling user controlled movement of the selected first item across the display;
displaying a menu of one or more actions, an action being associated with a respective portion of the display;
enabling user controlled selection of an action from the menu, wherein the user controlled selection of an action comprises user controlled movement of the selected first item to the portion of the display associated with the action; and
performing the selected action using the first data entity and the second data entity in response to user controlled movement of the selected first item to a second item that visually represents the second data entity, followed by the de-selection of the selected first item.

10. A method as claimed in claim 9, wherein the menu is displayed automatically.

11. A method as claimed in claim 10, wherein the menu is displayed in response to movement of the selected item.

12. A method as claimed in claim 9, wherein the menu is temporarily displayed, the display of the menu terminating with de-selection of the selected first item.

13. A method as claimed in claim 9, wherein the one or more actions of the menu are dependent upon the identity of the selected first item.

14. A method as claimed in claim 9, wherein the menu in the display is located at any one of a plurality of positions.

15. A method as claimed in claim 9, wherein the menu is positioned at an edge of the display.

16. A method as claimed in claim 9, further comprising highlighting, in the menu, the portion of the display associated with the selected action.

17. A method as claimed in claim 9, wherein a portion of the display that is associated with an action is labeled with a label that identifies that action.

18. An electronic device comprising:
a display for displaying items that visually represent data entities and for displaying a menu of one or more actions, an action being associated with a respective portion of the display; and
means for receiving a user input for selection of the item, for moving the selected item across the display, and for de-selecting the selected item,
wherein the electronic device is operable so that:
a first data entity is selected by selecting a first item that visually represents the first data entity;
an action is selected by moving the selected item to the portion of the display associated with the action; and
the selected action is performed using the first data entity and a second data entity by moving the selected first item to a second item that visually represents the second data entity and then de-selecting the selected first item.

19. An electronic device as claimed in claim 18, wherein the menu is automatically displayed when the drag and drop operation is initiated.

20. An electronic device as claimed in claim 18, wherein the menu has a content and the content of the menu depends upon which one of a plurality of items is involved in the drag and drop operation.

21. An electronic device as claimed in of claim 18, wherein the position of the menu varies for different drag and drop operations.

22. An electronic device as claimed in claim 18, wherein a portion of the display that is associated with an action is labeled with a label that identifies that action.

23. A computer program comprising computer program instructions which when loaded into a processor:
control displaying of a menu of one or more actions, an action being associated with a respective portion of the display;
detect user controlled selection of an action from the menu, wherein the user controlled selection of an action comprises user controlled movement of a selected first item to the portion of the display associated with the action; and
initiate performance of the selected action, which uses a first data entity and a second data entity, in response to the selected first item that visually represents the first data entity being moved to a second item that visually represents the second data entity and de-selected.

24. A computer program as claimed in claim 23, wherein the menu is automatically displayed when the drag and drop operation is initiated.

25. A computer program as claimed in claim 23, wherein the menu has a content and the content of the menu depends upon which one of a plurality of items is involved in the drag and drop operation.

26. A computer program as claimed in claim 23, wherein the position of the menu varies for different drag and drop operations.

27. A computer program as claimed in claim 23, wherein a portion of the display that is associated with an action is labeled with a label that identifies that action.

28. A graphical user interface that:
enables user controlled selection of a first item that visually represents a first data entity on a display;
enables user controlled movement of the selected first item across the display;
displays a menu of one or more actions, an action being associated with a respective portion of the display;
enables user controlled selection of an action from the menu, wherein the user controlled selection of an action comprises user controlled movement of the selected first item to the portion of the display associated with the action; and
enables performance of the selected action, which uses the first data entity and a second data entity, in response to the selected first item being moved to a second item that visually represents the second data entity and de-selected.

29. A graphical user interface as claimed in claim 28, wherein the menu is automatically displayed when the drag and drop operation is initiated.

30. A graphical user interface as claimed in claim 28, wherein the menu has a content and the content of the menu depends upon which one of a plurality of items is involved in the drag and drop operation.

31. A graphical user interface as claimed in claim 28, wherein the position of the menu varies for different drag and drop operations.

32. A graphical user interface as claimed in claim 28, wherein a portion of the display that is associated with an action is labeled with a label that identifies that action.

33. A method of controlling an action performed as a result of a drag and drop operation, the method comprising:
displaying a temporary menu of multiple actions during a drag and drop operation, an action being associated with a respective portion of a display; and
performing an action associated with a portion of the display that coincides with a waypoint or endpoint in the drag and drop operation.

34. A method of performing an action on a data entity, comprising:
enabling user controlled selection of an item that visually represents the data entity on a display;
while the item is selected, enabling user controlled movement of the selected item across the display;
automatically displaying a menu of one or more actions, an action being associated with a respective portion of the display;
enabling user controlled selection of an action from the menu, wherein the user controlled selection of an action comprises user controlled movement of the selected item to the portion of the display associated with the action;
performing the selected action on the data entity in response to user de-selection of the selected item; and
automatically terminating the display of the menu in response to user de-selection of the selected item.
